(19) United States
(12) Patent Application Publication
(10) Pub. No.: US 2010/0300254 A1
(43) Pub. Date: Dec. 2, 2010

(54) CUTTING SYSTEM FOR WIRE PROCESSING MACHINES

(75) Inventors: Stefan HOLDER, Pliezhausen (DE); Manfred SCHUKER, Dettlingen (DE); Markus TROST, Reutlingen (DE)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: WAFIOS AKTIENGESELLSCHAFT, Reutlingen (DE)

(21) Appl. No.: 12/781,653

(22) Filed: May 17, 2010

(30) Foreign Application Priority Data
May 28, 2009 (DE) 10 2009 022 969.8

(51) Int. Cl. B21F 11/00; B26D 5/14; B26D 5/08

(52) U.S. Cl. 83/13; 83/628; 83/617

(57) ABSTRACT

A wire processing machine having a cutting system, comprising a knife holder which carries a knife cooperating during a cut with a stationary counter-blade tool and is connected for performing a reciprocating motion by connecting means to an eccentric pin or a cam disk of a crankshaft, which on its part is driven by an electric motor, with the knife holder sliding in a guide during its reciprocating movement, which guide is arranged in a stationary manner or can be pivoted freely about an axis parallel to the rotational axis of the crankshaft in the case of a rigid connection of connecting means and knife holder, the crankshaft is driven directly by an asynchronous motor to which a gyrating mass is connected whose kinetic energy is released as a cutting force upon impingement of the knife on the wire, with the asynchronous motor performing precisely one rotation per cutting cycle and being controlled in such a way that it is accelerated up to the start of the cut and is braked after the cut has been performed.

This application claims priority to German Patent Application No. 10 2009 022 969.8 filed on May 28, 2009, said application is incorporated herein by reference in it's entirety.

### FIELD OF THE INVENTION

This invention relates to wire cutting systems for wire processing machines.

More specifically, the invention relates to a cutting system for wire processing machines, comprising a knife holder which carries a knife cooperating during a cut with a stationary counter-blade tool and is connected for performing a reciprocating motion by connecting means via an eccentric pin or a cam disk to a crankshaft, which on its part is driven by an electric motor, with the knife holder sliding in a guide during its reciprocating movement, which guide is arranged in a stationary manner or can be pivoted freely about an axis parallel to the rotational axis of the crankshaft in the case of a rigid connection of connecting means and knife holder.

### BACKGROUND OF THE INVENTION

Known cutting systems for wire cutting machines (spring making machines, bending machines, aligning machines, etc.) usually work with rapidly rotating synchronous servo motors and in addition with respective transmission gearings in order to enable providing the necessary cutting forces.

However, there are certain problems already from relatively small wire diameters (from approx. 3 mm) in the conventional cutting systems: In a wire with a diameter of 4 mm and a tensile strength of 2,300 MPa, e.g. cutting forces of approx. 20 kN are already required for the cut. During the severing of such a wire, cutting impacts occur which can easily destroy the highly sensitive encoder systems of the servo motors and therefore special measures (such as decoupling, damping, etc.) need to be taken. It requires a lot of effort and is also very expensive to realize such cutting forces via servo motors with respective gearings, damping or decoupling measures. From a certain level of the cutting force there are no servo motors with respective power values that would lead to a viable construction. It is therefore necessary in such cases to switch to multiple arrangements or other unfavorable alternatives such as a hydraulic drive or the like.

Furthermore, there are also no planetary gears with low play on the market from a certain magnitude (output torque >6,000 Nm), which, however, would be required to avoid that the cutting impacts occurring during the cut will not have a negative effect on the service life of the entire cutting system. On the other hand, the desired dynamics of the overall system are lost when using larger transmission gearings (e.g. when using rapidly rotating servo motors) and the duration for performing a cut is increased considerably.

Finally, conventional cutting systems with their servo motor drive usually require a highly sensitive encoder system for positioning the drive, which is mostly disposed right at the back on the motor, which means where acceleration is highest. Although such highly sensitive encoder systems can cope with vibrations with accelerations up to 50 g, they can still be exceeded considerably during the cutting of the wire, so that special measures for decoupling will be necessary.

A cutting system for a wire processing machine is known from JP 2007-069251A, in which the crankshaft of the cutting system is driven via five tool drive motors which are arranged in a star-like manner and are extremely low in inertia. This known multi-motor solution leads to increased mechanical input and considerably increased costs.

A coil winding machine is known from EP 0798058 B1 which is provided with a hydraulic cutting drive. This leads to the disadvantage of the necessity for providing a hydraulic system in the machine and larger expenditure in connection with the same.

Wire forming machines are known from DE 4138896 C2 and DE 4040659 C1, in which the employed cutting system for rotary cutting and straight cutting works with rapidly running servo drives. In order to convert the high speeds of the same into the required cutting forces, the servo drives need to work with transmission gearings in the form of belt drives, which leads to the disadvantages as already explained above in connection with such cutting systems and also requires a large constructional effort with a large number of individual components.

### SUMMARY OF THE INVENTION

It is therefore an advantage of embodiments of the invention to provide a cutting system for wire processing machines which realizes a sturdy, cost-effective drive solution without any transmission gearings and enables a free choice of the encoder system (irrespective of the motor manufacturer).

This is achieved in accordance with an embodiment of the invention in a cutting system of the kind mentioned above in such a way that the crankshaft is driven directly by an asynchronous motor to which a gyrating mass is connected whose kinetic energy is released as a cutting force upon impingement of the knife on the wire, with the asynchronous motor performing precisely one rotation)(360° per cutting cycle and being controlled in such a way that it is accelerated only up to the start of the cut and is braked after the cut has been performed.

Whereas asynchronous motors have not been considered to date as a drive for cutting systems of wire processing machines because they concern relatively sluggish and slower types of motors, this view is rejected in the invention for the first time and the possibility is thus offered to provide a direct drive of the crankshaft by the employed asynchronous motor in the cutting system in accordance with the invention and to completely omit interposing a transmission gearing. The asynchronous motor is controlled in such a way that it provides the required cutting energy within one rotation in the form of kinetic energy in the gyrating mass and the residual energy is braked immediately after the cut. This provides a cutting system which is relatively simple in its configuration and comprises few drive components and which omits the use of a transmission gearing. At the same time, the utilization of the kinetic energy of a gyrating mass driven by the asynchronous motor is provided for building up the required cutting energy. When using modern asynchronous motors it is possible in the meantime to provide the acceleration, cutting and braking of the cutting system within one rotation of the motor and during approx. 320 ms, with such time not concerning a minimum to time because the total time is determined substantially by the controller size and a further reduction seems to be possible. On the other hand, it is not so important because the spring manufacturing process for example requires considerably more time than the pure cut and the standstill period for the cut can be kept at a minimum by early starting of the cutting process (e.g. at a time when the spring has not yet been completely wound). Once the cutting knife has left the wire path again, the production of the next spring can be started (even when the cutting tool has not yet reached its idle position).

In an embodiment of the invention, the direct connection of the asynchronous motor to the crankshaft and the omission of a transmission leads to a considerable constructional simplification in comparison with known cutting systems, which may be accompanied at the same time by an especially robust arrangement of the cutting system in accordance with the invention. Since a predetermined gyrating mass is connected in the invention to the asynchronous motor whose kinetic energy is released upon impingement of the knife on the wire as a cutting force, which occurs in conjunction with the possibility offered in modern asynchronous motors to accelerate the gyrating mass within the shortest possible time in such a way that the kinetic energy required for the cutting process is made available (which depends on the diameter and the tensile strength of the wire to be severed), an overall configuration of the cutting system in accordance with the invention can be achieved which is less complex and more cost-effective. The cutting system in accordance with embodiments of the invention allows the use of simple external encoder systems and does not have to work with sensitive encoders integrated in the motor (as is usually the case in synchronous servo motors). Switch cams or proximity switches can be used for the position control of the asynchronous motor, which cams or switches concern simple, shock-resistant switching elements which can also be used close to the stiff machine wall and are thus only subject to low acceleration forces. These external encoders which are independent of the motor and which also include magnetic incremental encoders, inductive encoders and the like are sturdy. The risk of failure, despite the occurring cutting impacts, is considerably lower in comparison with that of highly sensitive encoder systems when using rapidly running servo motors.

In an embodiment of the invention, the gyrating mass can be formed by the rotor of the asynchronous motor if it has sufficient mass.

In an embodiment of the invention a sufficient gyrating mass is formed by the crankshaft.

In an embodiment of the invention, a separate gyrating mass is a flywheel.

The drive of the cutting system in accordance with an embodiment of the invention preferably occurs in such a way that the asynchronous motor, starting from a crankshaft position of 0°, is accelerated in the range of 0° to 180° and is braked again in the subsequent range up to 360°, with the cut occurring in the range of 160° to 180° and kinetic energy of the gyrating mass is released again in the form of cutting force upon impingement of the knife on the wire.

In a further embodiment of the invention, the acceleration of the cutting system in accordance with the invention occurs by vector control which is enabled by means of internal measurement of current and voltage and the known motor data of the asynchronous motor. Vector control leads to higher output (higher dynamics) of a frequency converter used for the operation of the asynchronous motor and therefore to higher dynamics of the asynchronous motor.

Devices which are suitable for converting the rotational movement of the crankshaft into a reciprocating movement can be used as connecting means between knife holder and eccentric pin of the crankshaft. The connecting means are arranged in an especially preferable way in the form of a connecting rod or a link guide cooperating with the eccentric pin of the crankshaft. Similarly, suitable cam drives can also be used in which a cam with a control cam to is provided on the crankshaft and the connecting means are arranged as follower elements (e.g. in the form of guide rollers rolling off on the cam surface) which cooperate with the control cam and are held to be in contact with the same at all times and in all angular positions.

The invention is now explained in principle in closer detail by way of example by reference to the drawings.

### DESCRIPTION OF THE DRAWINGS

FIG. 1 shows a cutting system in accordance with the invention in a schematic representation in a front view;

FIG. 2 shows the cutting system of FIG. 1 in accordance with the invention, but in a side view;

FIG. 3 shows a diagram of the curve of the motor speed of the asynchronous motor over time in a cutting system in accordance with the invention, and

FIG. 4 shows a partly intersected view of the cutting system in accordance with the invention in a perspective view.

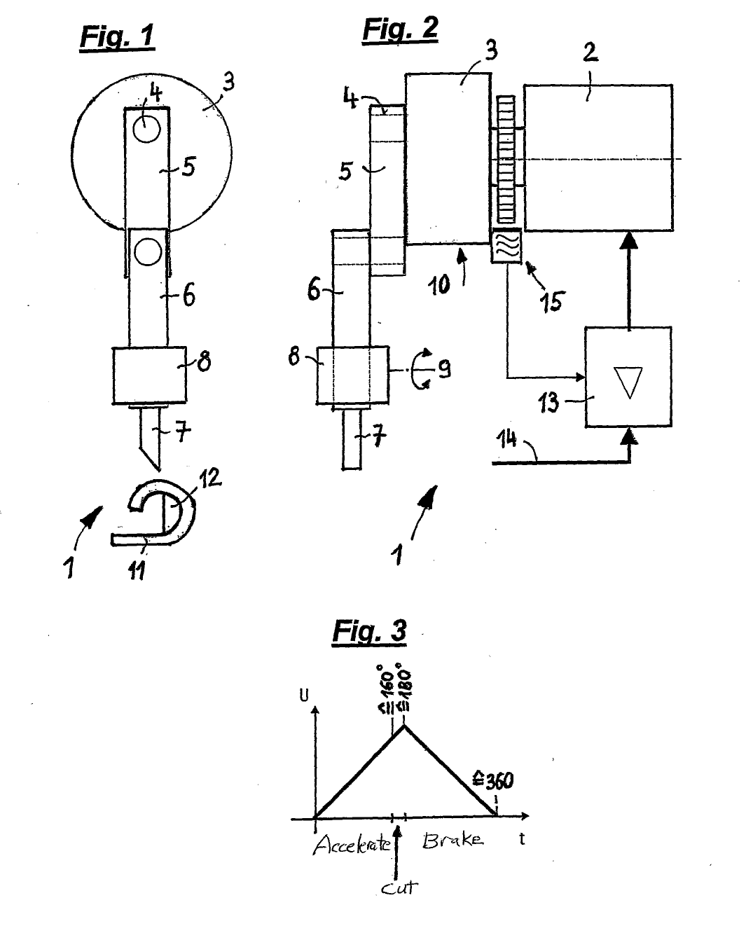

FIGS. 1 and 2 show a purely schematic illustration of a cutting system 1, with FIG. 1 showing the same in a front view and FIG. 2 in a side view.

The cutting system 1 comprises an asynchronous motor 2 which drives a crankshaft 3 directly, i.e. without interposing a transmission gearing (cf. the partly intersected view of the cutting system 1 in a perspective view in FIG. 4).

Crankshaft 3 is provided at its axial end opposite of the asynchronous motor 2 with an eccentric pin 4 to which a connecting rod 5 is linked which is linked to a knife holder 6 at its end averted from the eccentric pin 4, which knife holder is equipped on its part with a knife 7 for performing the cut on the wire.

The knife holder 6 runs in a guide 8 used as a bearing which is only shown in an entirely schematic way in FIGS. 1 and 2 and which can concern a carriage guide for example. Other suitable possibilities of a bearing or a guide 8 can be considered.

When the guide 8 consists of a bearing element which is fixed to the frame, the knife holder 6 with the knife 7 attached to the same performs a purely translational reciprocating motion (straight cut) during a rotation of the crankshaft 3.

When the guide 8 is arranged to be rotatable about a swiveling axis 9, as is indicated in FIG. 2, the connecting rod 5 and the knife holder 6 are rigidly connected with each other. In this case, the knife holder 6 with knife 7 performs a superimposed swiveling and translational movement during the rotation of the crankshaft 3, leading to an ellipsoid orbit of the knife 7 (rotational cut).

Any other form of cut is also possible, e.g. a can cut or the like, as long as there is sufficient time for acceleration, braking and return guidance of the cutting system 1 during operation.

In order to provide the cutting energy required for the cut, the asynchronous motor 2 drives a gyrating mass 10 whose kinetic energy is released again in the form of the cutting force during the impingement of the knife 7 on the wire 11 to be cut. The wire 11 is severed by knife 7 in cooperation with a counter-cutting tool 12 in the form of a mandrel. Once the severing of the wire 11 has occurred, the remaining kinetic energy of the gyrating mass 10 needs to be braked again, which occurs by braking of the asynchronous motor 2.

The cutting energy that is required in order to cut the wire 11 depends on the diameter and the tensile strength of the wire 11 to be cut. The necessary speed to which the gyrating mass 10 needs to be accelerated before the cut can be determined from this cutting energy and the inertia mass of the entire cutting system 1.

A separate flywheel can be used for example as a gyrating mass 10. The crankshaft 3 is used in the embodiment of FIGS. 1, 2 and 4 as the gyrating mass 10. It would also be possible to use the rotor of asynchronous motor 2 directly as a gyrating mass 10. The size of the employed gyrating mass 10 must be chosen to such a magnitude that the required cutting energy is available in the form of kinetic energy with a speed that lies within the speed range of the employed asynchronous motor 2.

The operation of the asynchronous motor 2 occurs via a frequency converter or, as indicated in FIG. 2, via a servo amplifier 13 with power supply 14. Furthermore, a contactless encoder system 15 is provided in which it may principally concern a magnetic incremental encoder or an inductive encoder or the like for example.

Such an encoder system is not principally required for driving the cutting system 1. Simple impact-resistant switching elements (e.g. switching cams or proximity switches) can also be actuated for controlling the position of the asynchronous motor 2.

In the simplest of cases, a switch cam is used which defines the zero position of the asynchronous motor 2. In contrast to FIG. 2, a switch cam 15′ is attached to the crankshaft 3 in the illustration according to FIG. 4, with the illustration of the counter-element of the encoder system cooperating with the same being omitted. Further switch cams can be provided as an extension, e.g. one before the plunging of the knife 7 into the wire path and a further switch cam after the rising of the knife 7 from the wire path, thus enabling a harmonization and optimization of the spring production cycles without any major effort.

The asynchronous motor 2 is activated via an impulse (supply with current), with the supply of current being stopped after passing the respective switch element and the cutting system 1 being braked by braking the asynchronous motor 2. Intermediate positions can also be defined by using several switching elements.

The asynchronous motor 2 which does not require any highly precise encoder system allows using simple encoder systems close to the (stiff) machine wall, through which the used to encoders are subjected to only very low acceleration forces.

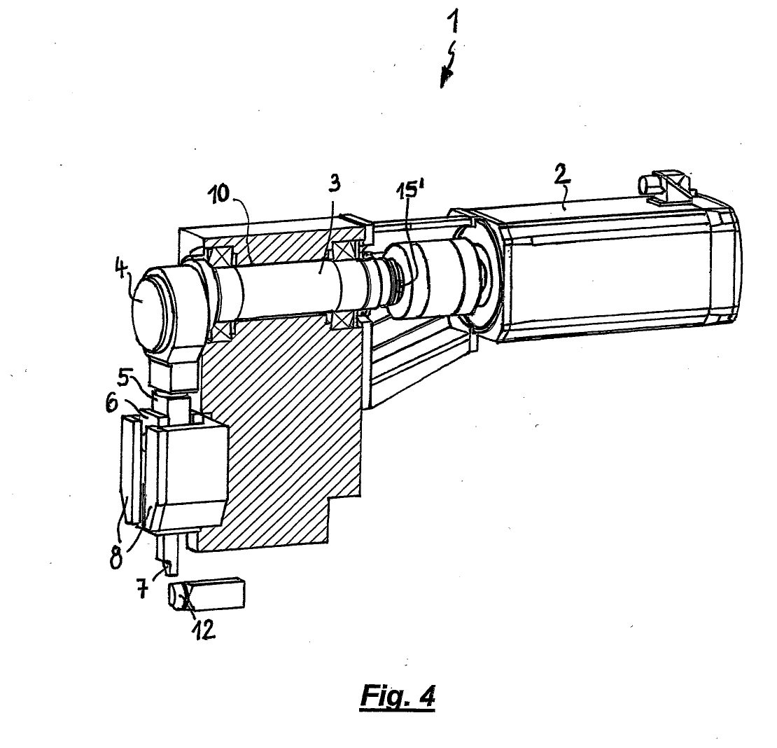

FIG. 3 shows a diagram of the curve of speed U of the asynchronous motor 2 for a rotation of the same, entered over time t. The numbers are given which correspond to the angular positions of the crankshaft 3 at 160° and 180° as well as 360°. The total duration of this rotation is 320 ms.

As is shown in FIG. 3, the cutting system performs precisely one rotation about 360° for each cutting cycle. During this rotation, merely 20% are required for severing the wire 11. The cut occurs within one rotation of the asynchronous motor 2 at a crankshaft position of 160° to 180° and does not require any separate transmission. The asynchronous motor is accelerated in the range of between 0° and 180° and braked thereafter up to 360°.

Although the description above contains many specificities, these should not be construed as limiting the scope of the invention but merely as providing illustrations of some of the presently preferred embodiments of the invention. Thus, the scope of the invention should be determined by the appended claims and their legal equivalents, rather than by the examples given.

1. A cutting system for wire processing machines, comprising a knife holder which with a knife cooperating during a cut with a stationary counter-blade tool and connected for performing a reciprocating motion to a crankshaft, an asynchronous electric motor, with the knife holder sliding in a guide during its reciprocating movement, which guide is arranged in a stationary manner or can be pivotal about an axis parallel to the rotational axis of the crankshaft wherein a gyrating mass is connected to the asynchronous electric motor, for providing kinetic energy that is released as a cutting force by impingement of the knife upon wire, and whereby the asynchronous motor performs precisely one rotation (360°) per cutting cycle and is controlled such that it accelerates before the cut and is braked after the cut has been performed.

2. A cutting system according to claim 1, wherein the gyrating mass is provided by the rotor of the asynchronous motor.

3. A cutting system according to claim 1, wherein the gyrating mass is provided by the crankshaft.

4. A cutting system according to claim 1, further comprising a separate flywheel providing the gyrating mass.

5. A cutting system according to claim 1, wherein the asynchronous motor, based on a crankshaft position of 0°, is accelerated in the range of 0° to 180° and is braked in the subsequent range of up to 360°, with the cutting process occurring in the range of 160° to 180°.

6. A cutting system according to claim 1, further comprising at least one of a switch cam and a proximity switch attached to the crankshaft for positional control of the asynchronous motor.

7. A cutting system according to claim 5, further comprising at least one of a switch cam and a proximity switch attached to the crankshaft for positional control of the asynchronous motor.

8. A cutting system according to claim 1, wherein the asynchronous motor works with a vector control for accelerating the system.

9. A cutting system according to claim 5, wherein the asynchronous motor works with a vector control for accelerating the system.

10. A cutting system according to claim 1, wherein the knife holder with a knife is connected to the crankshaft with a connecting rod or cam shift, the crankshaft linked to an eccentric pin or cam disk of the crankshaft.

11. A cutting system according to one of the claim 10, wherein a link guide cooperating with the eccentric pin of the crankshaft is provided as a connecting means.

12. A wire processing machine comprising a cutting system, the cutting system comprising:
an asynchronous electric motor;
a crankshaft connected to the motor;
a knife connecting to the crankshaft by way of a connecting rod and the knife constrained by a guide whereby reciprocating cutting motion is provided by the knife upon rotation of the crankshaft by the motor, and wherein the asynchronous motor is connected to the crankshaft such that a single rotation of the asynchronous motor translates to a single rotation of the crankshaft and one complete cutting cycle.

13. A wire processing machine of claim 12 wherein there is no transmission gearing between the electric motor and the crankshaft.

14. The wire processing machine of claim 12 further comprising a gyrating mass connected to the asynchronous motor, the gyrating mass providing kinetic energy upon the rotation of the asynchronous motor and the crankshaft, the gyrating mass positioned such that kinetic energy is released upon an impingement of the knife on a wire being cut, the gyrating mass comprising at least one of a flywheel, the crankshaft, and an armature of the electric motor.

15. The wire processing machine of claim 12 wherein the crankshaft may be positioned from 0° to 360° and further comprising a motor control configured such that the asynchronous motor is accelerated in the range of 0° to 180° and may be braked in the range of 180° to 360°.

16. A method of cutting wire in a wire processing machine comprising the steps of:
providing an asynchronous motor with a motion translation mechanism including a crankshaft having a rotational position of 0° to 360°;
providing the crankshaft connected to a cutting knife whereby a single rotation of the crankshaft translates into a single cutting cycle with a cutting process occurring in the range of 160° to 180°; and
controlling the asynchronous motor based on the relative position of the crankshaft or knife such that motor is accelerated when the crankshaft is in the range of 0° to 180° and is braked when in the range of 180° to 360°.

17. The method of claim 16 further providing a vector control to control the asynchronous motor.

18. The method of claim 16 further comprising driving the crankshaft directly by the electric motor without any transmission gearing therebetween.
